(19) United States
(12) Patent Application Publication
(10) Pub. No.: US 2021/0166164 A1
(43) Pub. Date: Jun. 3, 2021

(54) METHOD AND APPARATUS FOR BOARDING A VEHICLE

(71) Applicant: MOTOROLA SOLUTIONS, INC., CHICAGO, IL (US)

(72) Inventors: LEE M PROCTOR, CARY, IL (US); DONALD R CORNETT, CRYSTAL LAKE, IL (US); ERIC JOHNSON, CHICAGO, IL (US); GAIL BALLENGEE, ISLAND LAKE, IL (US)

(21) Appl. No.: 16/699,810

(22) Filed: Dec. 2, 2019

(51) Int. Cl. G06Q 10/06; G06F 3/0484

(52) U.S. Cl. CPC G06Q 10/0633; H04W 4/42; G06F 3/0484

(57) ABSTRACT

A method and apparatus for a method for alerting a next passenger to board a vehicle from a transportation hub is provided herein. During operation, a current seat score for each seat within the vehicle is determined. A plurality of gate scores for passengers waiting to board the vehicle is then determined. Finally, a next passenger to board is determined based on the current seat score for each seat within the vehicle and the plurality of gate scores of passengers. Once the next passenger to board is determined, a name of the next passengers will be announced and/or displayed on a monitor.

### BACKGROUND OF THE INVENTION

Oftentimes there exists significant delays in boarding planes, trains, busses, . . . , etc. Excessive boarding times may also cause significant customer dissatisfaction. Airlines, bus companies, and other transportation companies have tried many different techniques for efficient boarding, however, past solutions tend to be rigid procedures causing bottlenecks and are not flexible enough to adjust to real time situations.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a general operational environment of the present invention.

FIG. 2 is a block diagram of the server of FIG. 1.

FIG. 3 is a flow chart showing operation of the server of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to more efficiently board a vehicle, a method and apparatus for alerting a next passenger to board a vehicle from a transportation hub is provided herein. During operation, a current seat score for each seat within the vehicle is determined. A plurality of gate scores for passengers waiting to board the vehicle is then determined. Finally, a next passenger to board is determined based on the current seat score for each seat within the vehicle and the plurality of gate scores of passengers. Once the next passenger to board is determined, a name of the next passengers will be announced and/or displayed on a monitor.

The above-described technique for boarding improves upon existing techniques in that individuals are called to board one by one, instead of having everyone board simultaneously.

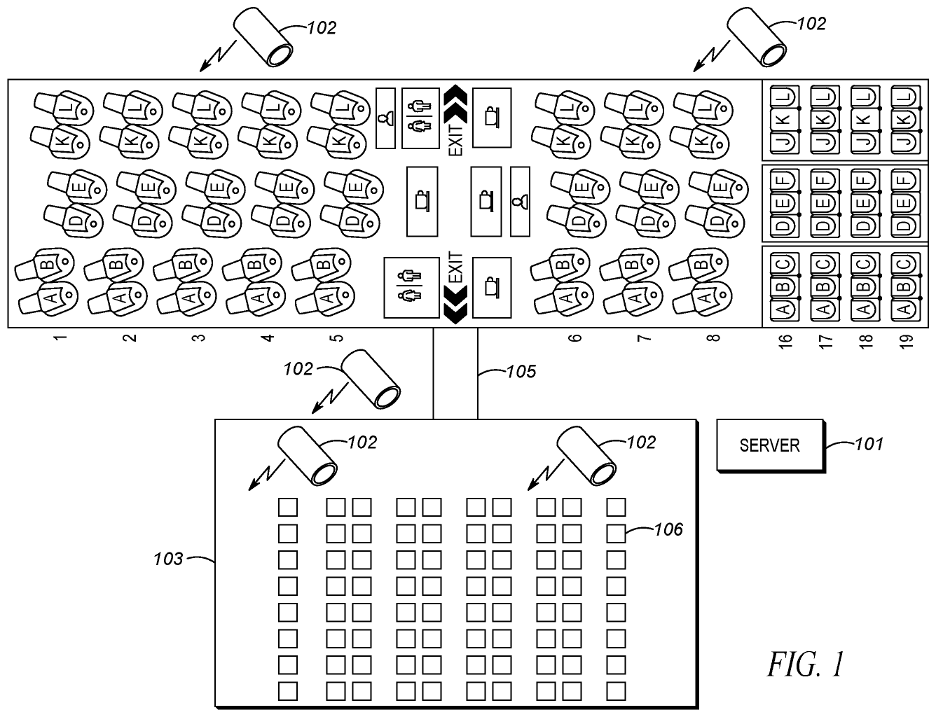

FIG. 1 illustrates a general operating environment of the present invention. As shown, vehicle 104 (in this case an airplane) is equipped with multiple cameras 102 positioned to capture individual seats and luggage storage areas (storage areas not shown in FIG. 1). In the present example, individual seats are categorized into rows (numbered) and columns (lettered).

Each camera 102 has a spatial area that a given camera can potentially view, referred to as a view shed. The view shed is based on the geographical location of the camera, mounting height, and pan-tilt-zoom capabilities of the camera while also accounting for physical obstructions of the field of view. In a preferred embodiment of the present inventions, a union of all view sheds for cameras 102 will at least include all seats within vehicle 104 along with all storage areas within vehicle 104.

As shown in FIG. 1, the general operating environment also comprises boarding area 103 (sometimes referred to as a gate). Area 103 comprises a plurality of seats 106 where passengers may reside prior to boarding vehicle 104. Passengers may also congregate by standing in open areas within gate area 103. In a preferred embodiment of the present inventions, the union of all view sheds for cameras 102 will also include all seats and congregation areas within boarding area 103.

Finally, transition area 105 is provided (sometimes referred to as a ramp or jetbridge), where users transition from boarding area 103 to vehicle 104. In a preferred embodiment of the present inventions, a union of all view sheds for cameras 102 will at least include ramps 105.

Finally, server 101 is provided. Server 101 is configured to determine a next passenger to board vehicle 104 from area 103, using ramps 105. Cameras 102 are attached (i.e., connected) to server 101 through a network (not shown in FIG. 1) via network interface. Example networks include any combination of wired and wireless networks, such as Ethernet, T1, Fiber, USB, IEEE 802.11, 3GPP LTE, and the like. During operation, server 101 receives feeds from multiple cameras 102, and then calculates a next person to board vehicle 104 from area 103 based on the camera feeds aiding in determining the current seat score for each seat within the vehicle and the plurality of gate scores of passengers.

Expanding on the above, server 101 determines a current seat score for each seat within the vehicle. A plurality of gate scores of passengers waiting to board the vehicle is then determined. Finally, the next passengers to board are determined based on current seat score for each seat within the vehicle, the plurality of gate scores of passengers.

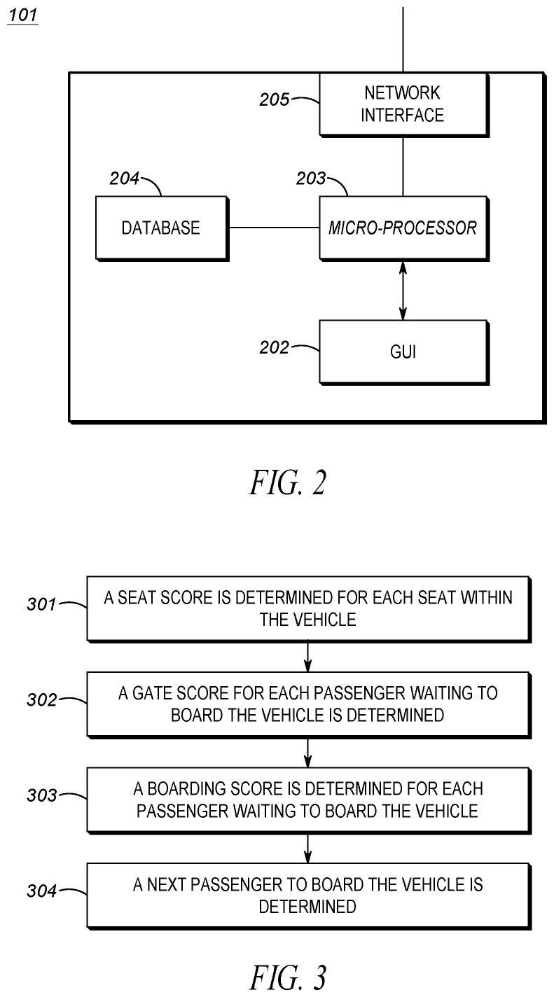

FIG. 2 is a block diagram of sever 101 of FIG. 1. As shown, server 101 comprises transceiver 201, logic circuitry 203, database 204, graphical-user interface (GUI) 202, and network interface 205. FIG. 2 shows those components (not all necessary) for server 101 to alert users wishing to board a vehicle of the next passenger that should board vehicle 104. In other implementations, server 101 may include more, fewer, or different components. Regardless, all components are connected via common data busses as known in the art.

GUI 202 provides a man/machine interface for displaying information. For example, GUI 506 may provide a way of conveying (e.g., displaying) information received from processor 203 as to which passenger(s) need to board next. Part of this information may comprise names of passengers. In order to provide the above features (and additional features), GUI 202 may comprise any combination of a touch screen, a computer screen, television screen, or any other interface needed to provide information to the passengers.

Database 204 comprises standard memory (such as RAM, ROM, . . . , etc.) and serves to store names of passengers along with biometric information for each passenger that can be used to visually identify the passengers. For example, facial recognition metrics may be stored for all passengers, or alternatively, an image of each passenger may be stored in database 204. Regardless of the information stored in database 204, database 204 comprises information/data used to visually identify passengers along with the names of the passengers. For example, if Joe Smith has a ticket to travel on vehicle 104 for a particular trip, database 104 will at least have a name “Joe Smith” stored, along with biometric information needed to visually identify “Joe Smith”.

The names of all passengers may be input to database 204 as tickets are purchased for the vehicle. Alternatively, GUI 202 may be utilized to manually input the names of all passengers into database 204.

As mentioned above, database 204 comprises biometric information and/or images used to visually identify each passenger. The biometric information/image may be populated within database 204 by capturing visual information (e.g. facial image(s), 3D facial mesh, driver's license photo, passport photo) of passengers at the time of ticket purchase or trip check-in. This may be done in a variety of ways. For example, in advance of the trip, the ticket purchaser may use their own smartphone or computer camera, in conjunction with a ticketing app or website, to capture images of themselves and their travel companions. Alternatively, a ticket sales agent (e.g. at a counter a transport terminal like an airport) may capture images of passengers using a computer-connected camera or other type of camera; a passenger may also use a ticket kiosk that is equipped with a camera (or within the viewshed of a fixed security camera) at a transport terminal to provide biometric information. In addition to capture at the time of ticket purchase or trip check-in, a passenger may capture biometrics as part of the process of signing up for a membership program or as part of enrollment in a pre-check service or personal identity management platform. Further, additional biometric data may be periodically collected each time a passenger takes a trip, walks through an area under video surveillance or provides their biometric information as a logical or physical access control factor. Beyond biometric data capture, a smartphone token may be provided to a passenger, e.g. via a transport provider's app, and/or RFID luggage tags intended for attachment to unchecked bags may be supplied to passengers. Tokens and radio frequency identification tags could be used as additional identity factors and to increase the reliability of passenger tracking as they move through the transport terminal.

Network interface 205 includes elements including processing, modulating, and transceiver elements that are operable in accordance with any one or more standard or proprietary wireless interfaces, wherein some of the functionality of the processing, modulating, and transceiver elements may be performed by means of the processing device 203 through programmed logic such as software applications or firmware stored on database 204 or through hardware. Examples of network interfaces (wired or wireless) include Ethernet, T1, USB interfaces, IEEE 802.11b, IEEE 802.11g, etc. Network interface 205 serves as means for logic circuitry 203 to obtain image/video data from cameras 102.

Finally, logic circuitry 203 comprises a digital signal processor (DSP), general purpose microprocessor, a programmable logic device, or application specific integrated circuit (ASIC) and is configured to determine a next passenger to board vehicle 104. More particularly, logic circuitry 203 determines the current seat score for each seat within the vehicle, and the plurality of gate scores of passengers. Logic circuitry 203 then maps this information to a next passenger to board.

The mapping process preferably comprises an operation that associates each element of a given set (the domain) with one or more elements of a second set (the range). The current seat score for each seat within the vehicle and gate scores for the passengers waiting to board comprise the domain, while names of passengers waiting to board comprise the range. The mapping may be explicit based on predefined rules, or the mapping may be trained via machine learning. The mapping produces the next passenger to board.

More specifically, if a current seat score for each seat within the vehicle (y), and a current gate score for the passengers waiting to board (z) are elements of the domain, it is said that f “takes the value” or “maps to” f(yz) at y and z. The set of possible outcomes of f(yz) is called the range. The mapping may be explicit based on predefined rules, or the mapping may be trained via machine learning. The mapping process preferably comprises an operation that associates each element of a given set (the domain) with one or more elements of a second set (the range). Thus:

Current person to board=Function(a current seat score for each seat within the vehicle, and a current gate score for the passengers for those waiting to board).

The server of FIG. 2 comprises logic circuitry configured to determine a seat score for each seat within the vehicle, determine a gate score for each passenger waiting to board the vehicle, and determine a boarding score for each passenger waiting to board the vehicle. The boarding score for each passenger waiting to board the vehicle is based on the seat score of a seat assigned to the passenger waiting to board the vehicle and the gate score for the passenger waiting to board the vehicle. The logic circuitry is also configured to determine a next passenger to board the vehicle based on the boarding score for each passenger waiting to board the vehicle. As discussed, a graphical user interface is provided, and configured to alert the next passenger that they should board the vehicle.

Determining a Current Seat Score for Each Seat within the Vehicle

Logic circuitry 203 continuously receives a camera image/video of the interior of vehicle 104 via interface 205, and is quickly able to determine what seats have been filled, what luggage bins have been filled, and where any crowding on the vehicle is occurring. This is accomplished by logic circuitry 203 performing analysis on all images/video using standard video analysis techniques. A seat score is then determined for each seat.

Each seat will have a dynamically updated seat score that will be adjusted based on the need and ease of boarding the person associated with that seat. Example criteria includes what seats are already occupied, the congestion status of the aisle in vicinity of the seat, the remaining capacity of overhead storage bins etc.

In a preferred embodiment seat scores will be stored in a matrix of M rows by N seat positions. M is the total number of rows in the plane and N is the maximum number of seats across the width of the airplane. Unused matrix elements will be set to the minimum value. Examples of unused matrix elements include non-existent seats (for example rows in first class with less seats per row) and in the case of non-full flights, seats with no currently assigned passengers. If subsequently, a previously unallocated seat is allocated to a passenger the corresponding seat score will be set to an appropriate value as per the algorithm below. An example of allocating a previously unallocated seat is a passenger previously on standby, or a passenger upgraded to a higher tier.

The seat score(m,n) is computed from several factors. In the preferred embodiment the factors and their associated weight is shown below. The values are for example only, and other values could be chosen and are considered to fall within the scope of invention. Additional factors and associated weights could also be used. In general, the higher the weight the more preferable it is to board a passenger assigned to that seat.

In determining the seat score for each seat, an unoccupied window seat is given a value of 100 due to the increased time for a passenger to seat themselves in a window seat. A middle seat is given a value of 50, if there are 3 seats on each side of the aisle. An aisle seat is given a value of 25 as passengers sitting in an aisle seat can impede the sitting of passengers assigned to seats closer to the window. Additional granularity could be given to the seat position scores based on other criteria, for example, whether in an emergency exit row or has additional leg room (and thus easier to be seated in).

Cabin Position. Seats towards the rear of the plane, or furthest from the boarding door, are given a value of 100. This is due to boarding too many people who are assigned to front seats can cause excessive congestion in the aisles. Seats towards the middle of the plane will be given a value of 50 and those in the vicinity of the boarding door, 25.

Aisle Congestion. The level of congestion in the aisle can be affected by several factors such as number of passengers, amount of luggage, passenger mobility etc. A heavy congestion, corresponding to a heavy bottleneck condition, is given a weight of 25. This weight is applied to all the seats within close vicinity (for example, the same row) of the aisle position. A free flowing section of aisle is given a weight of 100. Intermediate values (for example, 50) are assigned based on the level of movement of passengers through and within that section of aisle.

Seat Congestion. If all seats in the vicinity (for example, seats in that row) are fully occupied the Seat Congestion (m,n) value is set to zero. If all seats in the vicinity are empty the Seat Congestion (m,n) value is set to 100. A 50% occupancy in the vicinity gives a value of 50 and so on.

Overhead Capacity. If the overhead luggage bins in the vicinity of the seat are empty, the Overhead Capacity (m,n) is set to 100. If the overhead luggage bins are partially full the Overhead Capacity weight is set to 50. If the bins are full, the Overhead Capacity weight is set to zero. When an overhead luggage bin becomes full, an automatic notification is sent to the boarding area that luggage that will not fit under seats should be placed in the cargo hold.

For a seat in row m, isle n, the overall Seat Score (m,n) is equal to the Seat Position(m,n)+Cabin Position(m,n)+Aisle Congestion(m,n)+Seat Congestion(m,n)+Overhead Capacity(m,n). Higher Seat Scores will bias the overall boarding algorithm to select passengers for boarding that are assigned to those seats.

Although the above algorithm gives equal weight to each of the factors, different weights could be used to adjust how each factor affects the overall Seat Score. For example,

Seat Score (m,n)=W1*Seat Position+W2*Cabin Position+W3*Aisle Congestion+W4*Seat Congestion+W5*Overhead Capacity

The weights W1, W2 . . . W5 could be adjusted over time based on observed overall boarding performance. Alternatively, video analytics and data analytics could be used to automatically measure the overall boarding performance. This overall boarding performance and the measured Seat Score factors could be used as input to a machine learning algorithm for an artificial intelligence server. As more data is collected the artificial intelligence server could provide recommended values for each of the weights for a particular plane and expected passenger loading.

Note that Seat Position and Cabin Position are generally static factors and can be pre-configured based on the known configuration of the plane. The remaining factors are considerably more dynamic and will be refreshed periodically (for example every 10 seconds) or continuously recalculated. The information to calculate these values will be collected via the on-board video analytics, seat sensors and luggage bin weight sensors as previously described. When a passenger occupies a seat, the corresponding Seat Score (n,m) matrix element will be set to zero and unoccupied seats in the vicinity will have their Seat Congestion value updated.

Determining Gate Scores for Passengers

Logic circuitry 203 continuously receives a camera image/video of the gate area 103 via interface 205, and is quickly able to determine the identities of passengers waiting to board (via biometric information stored in database 204). For each passenger remaining to board, video analysis is done to determine a gate score for that passenger. The gate score may be based on how much un-checked luggage each passenger is associated with, a distance of each passenger from an entrance to vehicle 104, a club status level for the passenger, and/or how many passengers each passenger is travelling with.

As discussed, the gate score for each passenger takes into account various passenger and group attributes related to the aspects of boarding that are outside the vehicle and jetbridge. These attributes include ticket fare class, membership tier, quantity & sizes of unchecked luggage, distance from boarding zone or vehicle entrance, and number of passengers in group, along with a group multiplier and a group keep together flag.

Discrete values and ranges are stored per attribute (e.g. as key: value pairs). These attributes and values may be customized by each airline, allowing the airline to adjust the effective weight of different score factors.

Class is the ticket class purchased, and a class may have a numerical value, e.g. first class may have a value of 100, business class 75, economy plus 50, economy 25, and so on.

Membership tier is the club membership level/status assigned to a passenger. The more miles a passenger has travelled, and/or the more trips a passenger has traveled, the higher the passenger's dub status will be, Club status level is usually expressed in terms of 1 K (elite), Platinum, Gold, or Silver status. is at, and may have a numerical value, e.g. elite tier may have a value of 100, gold tier 75, silver tier 50, and so on.

Luggage reflects the quantity and size of unchecked luggage items, and may have a numerical value, e.g. one large and one small unchecked bag may have a value of 100, one large unchecked bag 75, one small unchecked bag 50, no unchecked bags 25, and so on.

Distance is a numerical value within a numerical range that is inversely proportional to the physical distance from a passenger to the boarding zone, jetbridge or vehicle entrance. While the measured physical dimension may vary depending on the size layout of the terminal or gate, the distance range may be mapped or scaled to the physical dimension so that it is, e.g. 1-100.

Individual factor is an attribute that enables an individual not to be out-ranked by a group in the boarding process. This may be a single value, e.g. 50.

Group count is the number of passengers in the group that the passenger is traveling with (e.g., family size). This value may be an integer from 0-n where n is the number of passengers in the group.

Group multiplier is used to scale the number of passengers in the group and may be a single value, e.g. 10.

Group keep together is a flag that is based on group type. This is to distinguish groups that need to be kept together during boarding, e.g. families, from groups that do not need to be kept together, e.g. people working for the same company. This attribute value is a boolean: true/false. Group type may be stored in the same database as this flag or may be retrieved from a different database.

Using the above attributes and values, the gate score is computed in the following manner. If a passenger is travelling alone or has a group keep together flag that is false, then their gate score is equal to the class value, plus membership tier value, plus luggage value, plus distance value plus individual factor value. Alternately, if a passenger is in a group and has a group keep together flag that is true, then their gate score, which may be applied to all members of their group, is equal to the highest class value in the group, plus the highest membership tier value in the group, plus the highest luggage value in the group, plus the distance value of group member who is closest to the boarding zone or vehicle, plus the group count value multiplied by the group multiplier value.

In addition to the fundamental computation described above, airlines may elect to apply customizable weighting coefficients to the various values in order to adjust the relative impact each component has on the overall gate score. Further, an additional true/false flag may be added for special case passengers, e.g. groups travelling with children younger than two years old, wheelchair-bound individuals, and the like in order to guarantee special treatment during the boarding process. Finally, machine learning may be applied to determine the impact that the computational elements have on real-world boarding efficiency and optimize the process. For example, video analytics may be used to analyze boarding video, taking into account passenger scores and rank metadata and, based on this, recommendations could be made to adjust the above attribute values, ranges and/or weighting coefficients. Updates to these elements could be also potentially be automated.

Determining a Next Passenger to Board

Each passenger remaining to board will receive a boarding score that is a summation of their seat score, and their gate score. The passenger having a highest boarding score will be determined as the next passenger needing to board. If multiple individuals share a same boarding score, then the next person to board may be chosen randomly from those sharing the highest score.

FIG. 3 is a flow chart showing operation of the server of FIG. 2. The logic flow begins at step 301 where a seat score is determined by logic circuitry 203 for each seat within the vehicle. At step 302, a gate score for each passenger waiting to board the vehicle is determined by logic circuitry 203. At step 303, a boarding score is determined by logic circuitry 203 for each passenger waiting to board the vehicle, wherein the boarding score for each passenger waiting to board the vehicle is based on the seat score of a seat assigned to the passenger waiting to board the vehicle and the gate score for the passenger waiting to board the vehicle. Finally, at step 304, a next passenger to board the vehicle is determined by logic circuitry 203 based on the boarding score for each passenger waiting to board the vehicle.

As discussed above, the next passenger is alerted via GUI 202 that they should board the vehicle.

Additionally, the step of determining the seat score for a seat may comprise the step of determining whether the seat is a window seat, an aisle seat, or a middle seat, and wherein the seat score for the seat is based on whether the seat is a window seat, an aisle seat, or a middle seat.

Additionally, the step of determining the seat score for a seat may comprise the step of determining a cabin position for the seat, and wherein the seat score for the seat is based the cabin position for the seat.

Additionally, the step of determining the seat score for a seat may comprise the step of determining aisle congestion around the seat, and wherein the seat score for the seat is based on an amount of aisle congestion around the seat.

Additionally, the step of determining the seat score for a seat may comprise the step of determining an amount of seat congestion around the seat, wherein the seat score for the seat is based on an amount of seat congestion around the seat.

Additionally, the step of determining the seat score for a seat may comprise the step of determining an amount of overhead storage capacity left above the seat, and wherein the seat score for the seat is based on the amount of overhead storage capacity left above the seat.

Additionally, step of determining the gate score for a passenger waiting to board the vehicle may comprise the step of determining a quantity and size of luggage associated with the passenger, and wherein the gate score for the passenger is based on the quantity and size of the luggage associated with the passenger.

Additionally, the step of determining the gate score for a passenger waiting to board the vehicle may comprise the step of determining a distance to the vehicle entrance for the passenger, and wherein the gate score for the passenger is based on the distance to the vehicle entrance.

Finally, the step of determining the gate score for a passenger waiting to board the vehicle may comprise the step of determining a number of passengers in a group associated with the passenger, and wherein the gate score for the passenger is based on the number of passengers in the group associated with the passenger.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for determining a next passenger to board a vehicle, the method comprising the steps of
determining a seat score for each seat within the vehicle;
determining a gate score for each passenger waiting to board the vehicle;
determining a boarding score for each passenger waiting to board the vehicle, wherein the boarding score for each passenger waiting to board the vehicle is based on the seat score of a seat assigned to the passenger waiting to board the vehicle and the gate score for the passenger waiting to board the vehicle;
determining a next passenger to board the vehicle based on the boarding score for each passenger waiting to board the vehicle.

2. The method of claim 1 comprising the step of alerting the next passenger that they should board the vehicle.

3. The method of claim 1 wherein the step of determining the seat score for a seat comprises the step of:
determining whether the seat is a window seat, an aisle seat, or a middle seat; and
wherein the seat score for the seat is based on whether the seat is a window seat, an aisle seat, or a middle seat.

4. The method of claim 1 wherein the step of determining the seat score for a seat comprises the step of:
determining a cabin position for the seat; and
wherein the seat score for the seat is based the cabin position for the seat.

5. The method of claim 1 wherein the step of determining the seat score for a seat comprises the step of:
determining aisle congestion around the seat; and
wherein the seat score for the seat is based on an amount of aisle congestion around the seat.

6. The method of claim 1 wherein the step of determining the seat score for a seat comprises the step of:
determining an amount of seat congestion around the seat, and
wherein the seat score for the seat is based on an amount of seat congestion around the seat.

7. The method of claim 1 wherein the step of determining the seat score for a seat comprises the step of:
determining an amount of overhead storage capacity left above the seat; and
wherein the seat score for the seat is based on the amount of overhead storage capacity left above the seat.

8. The method of claim 1 wherein the step of determining the gate score for a passenger waiting to board the vehicle comprises the step of:
determining a quantity and size of luggage associated with the passenger; and
wherein the gate score for the passenger is based on the quantity and size of the luggage associated with the passenger.

9. The method of claim 1 wherein the step of determining the gate score for a passenger waiting to board the vehicle comprises the step of:
determining a distance to the vehicle entrance for the passenger; and
wherein the gate score for the passenger is based on the distance to the vehicle entrance.

10. The method of claim 1 wherein the step of determining the gate score for a passenger waiting to board the vehicle comprises the step of:
determining a number of passengers in a group associated with the passenger; and
wherein the gate score for the passenger is based on the number of passengers in the group associated with the passenger.

11. An apparatus comprising:
logic circuitry configured to:
determine a seat score for each seat within a vehicle;
determine a gate score for each passenger waiting to board the vehicle;
determine a boarding score for each passenger waiting to board the vehicle, wherein the boarding score for each passenger waiting to board the vehicle is based on the seat score of a seat assigned to the passenger waiting to board the vehicle and the gate score for the passenger waiting to board the vehicle;
determine a next passenger to board the vehicle based on the boarding score for each passenger waiting to board the vehicle; and
a graphical user interface configured to alert the next passenger that they should board the vehicle.

12. The apparatus of claim 11 wherein the seat score for a seat is determined by determining whether the seat is a window seat, an aisle seat, or a middle seat.

13. The apparatus of claim 11 wherein the seat score for a seat is determined by determining a cabin position for the seat.

14. The apparatus of claim 11 wherein the seat score for a seat is determined by determining aisle congestion around the seat.

15. The apparatus of claim 11 wherein the gate score for a passenger waiting to board the is determined by determining a quantity and size of luggage associated with the passenger.
